(19) United States
(12) Patent Application Publication
(10) Pub. No.: US 2022/0025280 A1
(43) Pub. Date: Jan. 27, 2022

(54) UPGRADING SIMPLIFIED PROCESS FOR HEAVY OILS FLUIDIZATION DEDICATED TO THE HEAVY OILS TRANSPORTATION AND GREENHOUSE GAS REDUCTION

(71) Applicant: CLINIQUE DE VALORISATION- FOURNIER ET FILLES INC., Sherbrooke (CA)

(72) Inventor: Soumaine DEHKISSIA, SHERBROOKE (CA)

(21) Appl. No.: 17/450,652

(22) Filed: Oct. 12, 2021

Related U.S. Application Data
(63) Continuation of application No. PCT/CA2020/000044, filed on Apr. 3, 2020.
(60) Provisional application No. 62/832,960, filed on Apr. 12, 2019.

(51) Int. Cl. C10G 67/02

(52) U.S. Cl. CPC C10G 67/02; C10G 2300/302; C10G 2300/308; C10G 2300/202

(57) ABSTRACT

An economic and sustainable process is described herein for zeroing the addition of diluent required in heavy oils transportation by pipelines and by rails. The process reduces both heavy oils characteristics such as: (a) viscosity, (b) density, (c) acidic compounds (TAN), (d) sulfur and (e) olefins generated during the thermal treatment in order to meet stablished criteria for transportation. To prevent premature catalyst deactivation and precipitation, the solids materials in the crude heavy oil are removed first through a physical separation unit, and constitutes a fraction called solid fraction (≤30%), while the solids free fraction or de-solidified fraction (≥70%) of the heavy oil undergoes a thermo-catalytic treatment in a second unit under hydrogen pressure. During this step, both heavy oils properties listed above are reduced. Once produced, the olefins are then saturated by the hydrogen (or additive) present during the reaction yielding a stable treated heavy oil.

### CROSS-REFERENCE TO RELATED APPLICATIONS

This application is a continuation of International Patent Application Number PCT/CA2020/000044, filed on Apr. 3, 2020, which claims the benefit and priority of U.S. Provisional Application Ser. No. 62/832,960, filed on Apr. 12, 2019, the disclosure of each of which is incorporated herein by reference and on each of which priority is hereby claimed.

### BACKGROUND

Due to increasing world demand in energy and despite of efforts dedicated to the research of renewable energy, heavy oils remain presently the main solution. Unfortunately, these natural resources are produced far from cities or customers and thus, they must be transported by pipelines and/or by rails towards cities and/or other countries.

To satisfy both increasing world demand in energy and its policy of sustainable development, Canada with its proved reserve of 172 Gbbl (giga-barrel) is forecasting to increase the capacity of pipelines network from 4000 kbbl/d (kilo-barrel per day) in 2016 to 5550 kbbl/d as by 2030, along with a carbon tax of 50$/Ton of CO₂, starting as by 2022.

The difficulty is that, in addition to heavy oils or bitumen production cost, these materials are so viscous and cannot be pumped or transported as such. Thus, they must be upgraded to facilitate their transportation by pipeline. The heavy oils group includes oils which are classified by the American Petroleum Institute (API) or Canadian National Energy Board (NEB) as heavy oils, extra-heavy oils and bitumen.

Usually, heavy oil has a viscosity less than 10000 cP (centipoise) and an API gravity ranging between 10° API and 20° API, an extra-heavy oil has a viscosity less than 10000 cP with an API gravity less than 10° API, while bitumen has a viscosity greater than 10000 cP along with an API gravity less than 10° API. The heavy oils can be extracted from oil sands, atmospheric or vacuum distillation bottoms, shale oils, coal-derived liquids, crude oils residues, etc.

Due to thermal upgrading technologies disadvantages and the great volume of the diluent to be added (up to 30% vol. of diluent quoted at around 100$/bbl. sometimes), the producers are already facing financial problem. In fact, the properties of heavy oils to be transported must satisfy several criteria. Some among these properties can expose the price of the barrel to applicable discounts (olefins, TAN, S, etc.) in case of luck to meeting these specifications. According to a document produced by the World Bank, for crude oil containing a TAN of 4.7 mgKOH/g (case of Chad crude oil), the imposed discount will be as high as 11.81$US/barrel when the price of the Brent (TAN=0.07 mgKOH/g) is 50$US/barrel (based on 0.051$US per excess point, per barrel of Brent).

Given that greenhouse gases (GHG), is an increasing function of bitumen production, the challenge will be great for the producers because the government is encouraging bitumen production and at the same time it is imposing a carbon tax. In such circumstances, innovative and ideal sustainable process will be (this one which is) able to both eliminate diluent use and reduce GHG production in addition to meeting specified criteria.

Regarding bitumen upgrading for transportation, many processes such as thermal treatment technologies (distillation, Coking, thermal cracking and/or hydrocracking) to reduce viscosity and density, diluent addition method and current emerging partial upgrading processes were evaluated.

Thermal Technologies

Among the upgrading thermal technologies, cracking is source of instability while the coking process (as big as 88 m×10 m) yields is limited because a larger and very heavy residues solubilized in a maltenic medium is formed as viscous by-product. Only hydrocracking process achieves balance between light-hydrocarbon, middle distillate yields and catalyst cost and longevity.

Meanwhile, the complexity of heavy oils structure due to the presence of huge amount of asphaltenes, is a limiting factor for intimate contact between heavy oils matrix and the catalyst active sites. Additionally, and on an elemental analysis basis, materials such as asphaltenes are rich in carbon, thus, susceptible to generate significant GHG during thermal treatment.

The configuration of all these technologies in current petroleum industry, associated with distillation units are not only complex and energy consuming, but also source of GHG since each operating unit is producing GHG.

Furthermore, such complex technologies constitute a factor of increasing OPEX and CAPEX. Processed bitumen resulting from thermal technologies is often not stable and do not meet all transportation criteria, and huge quantity of tailing is produced by the process such as coking and needs facilities for disposal or management.

U.S. Pat. No. 5,096,566 discloses a jet shear based method for viscosity reduction of a coker feedstock aiming at the limitation of coke formation. However, this reference or paper is not addressing the heavy oil transportation.

This fact partially explains why industries moved towards the use of light hydrocarbons as diluting agent in order to physically but not chemically enhance or modify the properties of the so called heavy-oils and/extra heavy oils to at least facilitate their transportation.

Diluent Addition Method

Diluent, a light hydrocarbon cut (density: 600-800 kg/m³) is currently the solution of choice largely used by the company members of the “Canadian Energy Pipelines Association (CEPA)”, which is in charge of heavy oils transportation. The Canada forecasts to produce up to 5.55 Mbbl/day by 2030 and given the needed proportion of 30% vol. of diluent versus 70% vol. of bitumen to yield a 100% vol. of dilbit for transportation. Considering the diluent price, it is clear that transporting for example 100 kbbl/d of a such dilbit is source of concerns for the producers in terms of cost.

Considering the establishment of carbon tax (50$/ton of CO₂), and taking into account the following reasons, the producers will be in danger if nothing is not done.

First, addition of diluent in the known proportion of ca. 30% vol., constitutes a great concern for the bitumen producers in that the diluent is so expensive (e.g.: cost was =100$/bbl. as by 2014). For such example, to ship a volume of 100 kbbl/d of a given dilbit, it costs more that 1 billion$ (1.095 G$/yr).

In addition to the diluent cost, there are several disadvantages associated with the use of diluent. The availability of diluent is questionable in some remote locations (e.g.: in Canada half of diluent presently in use, is imported). Production of diluent from natural gas (e. g.: 37kgCO₂/bbl.) and its use as dilution agent are sources of GHG. Not the less, in case of accidental spilling, the diluent can represent an environmental risk.

Emerging Technologies for Heavy Oils Upgrading and Transport

In year 2018, the government of Alberta invested millions of dollars in the development of partial upgrading technologies initiated during the work of Dr. S. Dehkissia thesis since 2004. U.S. Pat. No. 8,105,480 B2 discloses a jet shear-based method similar to U.S. Pat. No. 5,096,566 for viscosity reduction, addressing heavy oils transportation.

The drawbacks of this later method is that it does not satisfy all transportation criteria, but still requires addition of diluent (with a reduction of about 50% vol.) and implies separated units for reduction of olefins contained in the light fraction, TAN (see U.S. Pat. No. 9,745,525), viscosity or density. Furthermore, the nozzles of such system need to be replaced periodically. It is a process focusing on the cavitation and mechanical effects.

U.S. Pat. No. 9,976,093 B2 discloses a method limited to asphaltenes separation, while U.S. Pat. Nos. 9,944,864 B2 and 9,890,337 B2, discloses methods for producing pipeline-ready or refinery-ready feedstocks. Unfortunately, few information is available regarding the feedstocks' and products' properties. It is known that thermally processing a crude material containing high content in asphaltenes prior to asphaltenes removal, as it is the case, is source of deasphalted oil (DAO) instability. Furthermore, the materials being processed without catalyst and hydrogen, the treated feedstocks are susceptible to be submitted to TAN and/or to sulfur and olefins discounts. The portion of concentrated asphaltenes removed from feedstock constitutes serious environmental concerns, even if it is used in the co-regeneration.

US publication No 2017/0002275A1 discloses a method for bitumen processing and transport. The weak points of this process are numerous. First, it implies two types of asphaltenes separation from oil in two asphaltenes fractions, which are then mixed and forming an asphaltenes prill in deasphalted oil. To control the density of asphaltenes prill, one or more hollows portions are added to prill along with addition of one or more diluents and/or the hydrocarbon material is submitted to thermal visbreaking. Of course, the feedstock from such process is subject to TAN, Sulfur and olefins discounts in addition to its instability.

U.S. Pat. No. 9,206,359B2 discloses a process for upgrading contaminated hydrocarbons feeds with both caustic solution and a selective promoter rending subsequent separation very complex. Furthermore, the disclosed method implies the decontamination of the whole hydrocarbon feeds, which makes the process very expensive and time consuming.

US publication No 2014/0209513A1 exhibits a complex process for coal liquefaction. The process of supersaturated dispersion containing both solid, liquid and gas occupies more volume, in addition to high amount of catalyst, high temperature, high pressure/and hydrogen partial pressure required to prevent catalyst aging in the reaction medium. It also requires pumps made with durable materials such as ceramics. Furthermore, no results were reported in this patent to show the feasibility of such process.

US publication No 2006/0118467A1 discloses a method of transporting heavy crude oils in dispersion, but the process only focuses on the viscosity reduction among others criteria (TAN, Sulfur, density, etc.) required. There is no specification of the viscosity to be reached. The heavy crude being not treated, it requires addition of very expensive diluent with known concerns (GHG, spilling, etc.) associated to its use.

U.S. Pat. No. 10,358,610 B2 also discloses a method for partial upgrading of heavy oil transportation by pipeline. The effect of solid materials such asphaltenes, metals and salts on the catalyst deactivation being known, mixing whole heavy oil with the catalyst not only requires huge quantity of catalyst, but also these catalytic materials will undergo a premature deactivation. Furthermore, the use of continuous stirred reactor is not practical at an industrial level and it causes catalyst particles attrition. High temperature, which is source of instability, is required for operation along with high hydrogen consumption. The method also results in equipment's damage.

U.S. Pat. No. 5,976,360 discloses a process for viscosity reduction by thermal treatment. A first drawback of this process is that it is far to meet Canada's specifications of viscosity for transportation (350 cSt at 12° C.). The process tested on conventional crude oil also leads to acidic compounds (designated as TAN) reduction, although this later is time consuming. The efficiency of such method with extra-heavy oils or bitumen to meet viscosity, density, etc., is questionable under reported operating conditions, and there are no reported data on the instability of the treated materials, as well as on the density and olefins content.

Currently, there is no process able to respond economically and environmentally to the challenging problem of bitumen upgrading and transportation. Considering a) the forecasted bitumen production (5.55 Mbbl/day as by 2030) and carbon taxes of 50$/ton of CO₂; b) cost of diluent (e.g.: =100$/bbl as by 2014) to be added up to 30% vol. which impacts the volume to be shipped; and c) the difficulty to meet criteria established for heavy oils transportation and the resulting discounts, it appears urgent to develop a innovative and sustainable process.

### SUMMARY

To deliver producers from unbearable costs of diluent and carbon tax, the objectives of this simplified process according to illustrated embodiments are to reduce GHG production/carbon tax, zeroing diluent cost and diluent recycling, reducing Opex and Capex, increasing both the volume of bitumen to be shipped and bitumen value as well via improvement of its quality to meet key criteria, and avoiding discounts.

To reach all these goals, an illustrative embodiment of the process includes the feedstock being first separated in two (2) fractions: a fraction constituted by solids materials and named Solids Fraction (SF) and a second fraction called de-solidified fraction (DS-F) containing fluid to semi-fluid like materials. The de-solidified fraction (DSF) is routed to a subsequent main unit for a thermo-catalytic fluidization reaction, in the presence of an additive such as hydrogen, leading to a fluidized de-solidified Fraction, FDSF. When needed, in order to satisfy new marine fuel standard of 0.5% S, the solid fraction (SF) (with the H₂S produced for example by a thermo-catalytic reaction, undergoes a desulfurization step for example through a caustic solution, but not limited, to yield a desulfurized solid fraction, noted DSSF. The solid fraction (SF) or the desulfurized solid fraction (DSSF) free from sulfur, metals and/or fines particles is then combined with fluidized de-solidified fraction, said FDSF to produce a Synthetic Crude Oil (SCO), meeting required criteria and ready for transportation by pipeline or rails.

According to an illustrative embodiment, a process having a simplified configuration dedicated to heavy oils upgrading aiming to reduce GHG production or carbon tax, zeroing diluent cost, reducing Opex and Capex increasing both volume of bitumen transportation facilities and bitumen value by improving its quality or meeting required transportation criteria, comprises:

removing or separating the solids fraction (SF), yielding a de-solidified fraction (DSF);

subjecting the de-solidified fraction (DSF) under thermal treatment, yielding a fluidized de-solidified fraction (FDSF).

According to a more specific embodiment, in order to satisfy new marine fuel standard of 0.5% S, the solid fraction (SF) is further washed or desulfurized with a saline solution, e.g.: caustic solution to removed heteroatoms such as sulfur, nitrogen, oxygen, etc., then, this desulfurized fraction, DSSF, is remixed with the fluidized de-solidified fraction (FDSF) to generate a Synthetic Crude Oil, SCO ready for remote locations or international market transportation.

The heavy oils as received may contain diluent from production field at trace level or at a given percentage.

For example, the DSF is treated according to specific conditions or according to given ranges of temperatures, additive or hydrogen pressure and residence times.

Other objects, advantages and features of the present process will become more apparent upon reading the following nonrestrictive description of illustrated embodiments thereof, given by way of example only with reference to the accompanying drawings.

### BRIEF DESCRIPTION OF THE DRAWINGS

In the appended drawings:

FIG. 1 is a schematic view of a heavy oil partial upgrading process according to an illustrative embodiment.

### DETAILED DESCRIPTION

In the following description, similar features in the drawings have been given similar reference numerals, and in order not to weigh down the FIGURES, some elements are not referred to in some FIGURES if they were already identified in a precedent FIGURE.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements.

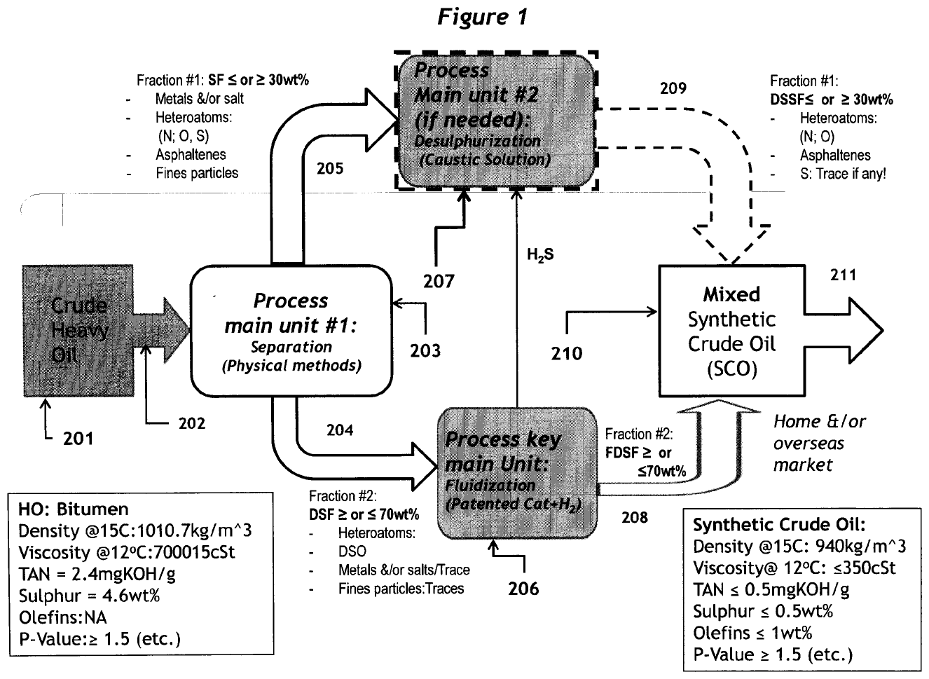

With reference to FIG. 1, an apparatus dedicated to heavy oils upgrading according to an illustrative embodiment includes a heavy oils or dilbit tank 201, a physical separation unit 203, the solids fraction decontamination or desulfurization unit 207, the key main unit for catalytic fluidization 206, and a mixing or receiving tank 210 to yield Synthetic Crude Oil.

The preheated heavy oil or dilbit from the tank 201 enters the separation unit 203, through conduit 202, wherein the separation is carried below 350° C. and 1000 Psig, without limitations, via a breathing semi-fluidized bed or a fixed bed of inert materials or via any other means of separation.

As a result, two fractions are generated: a solid fraction SF representing ≤30 wt %, and a de-solidified fraction DSF, accounting for ≥70 wt %. It is to be noted that sometimes, but rarely, the percentage of SF is greater than 30 wt % and the percentage of DSF is lower than 70 wt %.

The presence of solids materials during hydrocarbons processing is a real danger in that they are responsible of fines deposition and can lead to catalyst bed plugging and catalysts deactivation.

The removal of solids materials (metals, fines particles, asphaltenes, heteroatoms etc.) prior to heavy oils thermo-catalytic treatment, avoids such problems to the catalysts inserted in the downstream units.

The de-solidified fraction is then routed via conduit or line 204, to the key main unit 206 for fluidization reaction above 350° C. & 400 Psig through a catalytic semi-fluidized bed or a catalytic fixed bed, as well as any other catalytic bed using a catalyst material associated with a given additive, such as hydrogen.

The presence of the catalyst and hydrogen in the reaction medium play two roles: a) the catalytic treatment breaks down the macromolecules forming the de-solidified fraction DSF, to yield a fluidized de-solidified fraction FDSF (≥70% wt %, but not limited) with lower viscosity and density well below the values set as criteria for the transportation; b) elsewhere, said thermo-catalytic treatment in the presence of hydrogen improves at the same time others qualities of material and avoids the possible discounts.

In fact, when hydrogen is present in the thermo-catalytic medium, cracked molecules, particularly olefins are saturated and treated heavy oil become stable (stability index, P-Value≥1.5). The sulfur is eliminated in form of H₂S, while acidic components often concentrated in the cut ranging from 232 to 427° C. (according to Merichem and Nalco Inc.), are eliminated or destroyed, which is beneficial for producers.

In another embodiment dedicated to local market, fluidized de-solidified fraction, FDSF, from line 208 is considered as refinery feedstock and solid fraction from line 205 is used in gasifier, co-regeneration, but not limited.

Thirdly, if needed, in order to satisfy new marine fuel standard of 0.5% S, the isolated solid fraction, SF from separation unit enters the decontamination unit 207, through conduit 205, whereby it undergoes (together or not with the produced H₂S) a desulfurization step in contact with a saline solution such as caustic solution, but not limited, to yield a desulfurized solid fraction, noted DSSF (≤30 wt %, but not limited).

The desulfurized solid fraction, DSSF, free from sulfur, metals and fines particles exits through conduit 209 and is then combined with fluidized de-solidified fraction, FDSF, from conduit 208 to generate the so-called Synthetic Crude Oil (SCO), meeting required criteria and ready for transportation by pipeline or rails.

### Example

A fluidization experiment was carried out according to the apparatus illustrated in FIG. 1. An Athabasca bitumen having the properties indicated in table #1 below was used as feedstock.

TABLE 1
Results from catalytic fluidization or upgrading at 420° C.
and WHSV = 4/h under 2000 Psig

| | | | | | SCO for |
|---|---|---|---|---|---|
| | | | | | overseas |
| Upgraded | | | Upgraded | | or |
| products | | | products | Home/ | inter- |
| vs HO key | Properties | Feedstock | Properties | FDSF | national |
| properties | units | HO | specs. | refineries | markets |
| API gravity | (°) | 8.50 | ≥19 | 32 | 19 (ok) |
| @15.6° C. | | | | | |
| Viscosity | (cP) | 700015 | ≤350 | 90 | ≤150 (ok) |
| @12° C. | | | | | |
| TAN | (mg- | 2.41 | ≤1.0 | 0.5 | 0.63 (No) |
| | KOH/g) | | | | |
| Sulfur | (wt %) | 4.60 | ≤0.5 | 0.4 | 0.81 (No) |
| reduction | | | | | |
| Olefins/ | (g-Br₂/ | — | ≤10 | 5 | 3.87 (ok) |
| Bromine | 100 g)* | | | | |
| Nbre | | | | | |
| Stability | (—) | NA | ≥1.5 | 3.0 | 2.5 (ok) |
| P-Value | | | | | |

Legend: (ok): Specification is satisfied;
(No): Specification is not satisfied;
(NA): Data is not available;
*10 g-Br2/100 g is equivalent to: 1 wt % of olefins;

The Athabasca bitumen having a viscosity of 152015 cP and 700015 cP respectively at 15° C. and 12° C. was fluidized in the conditions indicated above (details are not shown herein). The properties of the different products, including FDSF and SCO are presented in table#1. The observation made based of these results is that the objectives fixed by the current process are met on dispute of minor variations due to measurements or operating conditions (e.g.: case of SCO) and which can be improved.

Although a process for heavy oils fluidization dedicated to the heavy oils transportation and greenhouse gas reduction has been described hereinabove by way of illustrated embodiments thereof, it can be modified. It is therefore to be understood that numerous modifications may be made to the illustrative embodiments and that the scope of the claims should not be limited by the preferred embodiment, but should be given the broadest interpretation consistent with the description as a whole.

What is claimed is:

1. A process for heavy oil upgrading comprising:
removing a solid fraction (SF) of the heavy oil using a breathing semi-fluidized bed, resulting in a de-solidified fraction (DSF); wherein the SF represents less than 30 wt % of the heavy oil;
washing or desulfurizing the SF with a saline solution to remove heteroatoms, resulting in a desulphurized solid fraction (DSSF);
subjecting the DSF under thermal treatment in presence of a catalyst and hydrogen so as to produce a fluidized desolidified fraction (FDSF); and
remixing the DSSF and the FDSF to generate a Synthetic Crude Oil (SCO).

2. The process according to claim 1, wherein the heavy oil contains diluent from production field at trace level or at a given percentage.

3. The process of claim 1 wherein the DSF represents more than 70 wt % of the heavy oil.

4. The process according to claim 1, wherein the FDSF is further used as feedstock in a local refinery.

5. The process according to claim 1, wherein said removing a solid fraction (SF) of the heavy oil is carried below 350° C. and 1000 Psig.
